(19) United States
(12) Patent Application Publication
(10) Pub. No.: US 2025/0036694 A1
(43) Pub. Date: Jan. 30, 2025

(54) SYSTEMS AND METHODS FOR IMPROVING TERM GENERATION USING HEURISTIC REFINEMENT AND DEEP LEARNING

(71) Applicant: YAHOO ASSETS LLC, New York, NY (US)

(72) Inventors: Xinyue WANG, New York, NY (US); Liuqing LI, New York, NY (US); Donghyun KIM, New York, NY (US); Yufeng MA, New York, NY (US); Rao SHEN, New York, CA (US); Kostas TSIOUTSIOULIKLIS, New York, NY (US)

(21) Appl. No.: 18/359,089

(22) Filed: Jul. 26, 2023

(51) Int. Cl. G06F 16/9532; G06F 16/28; G06F 16/9535

(52) U.S. Cl. CPC G06F 16/9532; G06F 16/284; G06F 16/9535

(57) ABSTRACT

Systems and methods are disclosed for using heuristic refinement and a deep learning model to identify at least one high-quality user search query. One method comprises filtering one or more queries, determining at least one candidate query based on the filtered queries, the determining including: determining heuristic candidate queries by applying heuristic processes to the filtered queries, generating model candidate queries based on one or more deep learning model processes, and selecting the candidate query from the heuristic candidate queries or the model candidate queries based on a corresponding aggregated token frequency, and displaying the candidate query.

### TECHNICAL FIELD

The present disclosure relates to improving recommendations and, more particularly, to systems and methods for using heuristic refinement and a deep learning model to identify at least one high-quality user search query.

### BACKGROUND

Online data services (e.g., news services) play a vital role in disseminating information among web users. A substantial amount of information is published online, and as a result, many challenges arise. For example, users desire to efficiently access their desired information quickly among the substantial amount of information presented to the users. Conventional approaches to address such an issue may rely on web backlog indicators that measure user engagement. For example, conventional approaches may rely on user views and clicks to determine which content is popular, and thus, may be recommended to a user. However, due to differences in online traffic size and user behavior patterns, user involvement is typically inconsistent, which may impact the quality of topic recommendations. Additionally, popular user search queries may be one of the primary sources for providing user recommendations. However, such queries do not ensure a high-quality event summary because they may miss essential event facts. Conventional approaches may include keyword/key phrase extraction, however, such approaches may rely heavily on an adequate amount of text data to identify the common key terms in a given event.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

Embodiments of the present disclosure include systems and methods for using heuristic refinement and a deep learning model to identify at least one high-quality user search query.

According to certain embodiments, computer-implemented methods are disclosed for using heuristic refinement and a deep learning model to identify at least one high-quality user search query. One method may include filtering, by one or more processors, one or more queries based on one or more user interactions. The method may further include determining, by the one or more processors, at least one candidate query based on the filtered one or more queries, the determining including: determining, by the one or more processors, one or more heuristic candidate queries by applying one or more heuristic processes to the filtered one or more queries, generating, by the one or more processors, one or more model candidate queries based on one or more deep learning model processes, and selecting, by the one or more processors, the at least one candidate query from the one or more heuristic candidate queries or the one or more model candidate queries based on a corresponding aggregated token frequency. The method may further include displaying, by the one or more processors, the at least one candidate query on at least one device.

According to certain embodiments, a computer system for using heuristic refinement and a deep learning model to identify at least one high-quality user search query is disclosed. The computer system may comprise a memory having processor-readable instructions stored therein, and one or more processors configured to access the memory and execute the processor-readable instructions, which when executed by the one or more processors configures the one or more processors to perform a plurality of functions. The functions may include filtering one or more queries based on one or more user interactions. The functions may further include determining at least one candidate query based on the filtered one or more queries. The determining may include determining one or more heuristic candidate queries by applying one or more heuristic processes to the filtered one or more queries, generating one or more model candidate queries based on one or more deep learning model processes, and selecting the at least one candidate query from the one or more heuristic candidate queries or the one or more model candidate queries based on a corresponding aggregated token frequency. The functions may further include displaying the at least one candidate query on at least one device.

According to certain embodiments, a non-transitory computer-readable medium containing instructions for using heuristic refinement and a deep learning model to identify at least one high-quality user search query is disclosed. The instructions may include filtering, by one or more processors, one or more queries based on one or more user interactions. The instructions may further include determining, by the one or more processors, at least one candidate query based on the filtered one or more queries. The determining may include determining, by the one or more processors, one or more heuristic candidate queries by applying one or more heuristic processes to the filtered one or more queries, generating, by the one or more processors, one or more model candidate queries based on one or more deep learning model processes, and selecting, by the one or more processors, the at least one candidate query from the one or more heuristic candidate queries or the one or more model candidate queries based on a corresponding aggregated token frequency. The instructions may further include displaying, by the one or more processors, the at least one candidate query on at least one device.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a schematic diagram illustrating an example environment implementing methods and systems of this disclosure, according to one or more embodiments.

FIG. 2 depicts a flow diagram of an exemplary method using heuristic refinement and a deep learning model to identify at least one high-quality user search query, according to one or more embodiments.

FIG. 3 depicts a schematic diagram of an exemplary method of determining a candidate term, according to one or more embodiments.

FIG. 4 depicts an example system that may execute techniques presented herein.

### DETAILED DESCRIPTION OF EMBODIMENTS

According to certain aspects of the disclosure, methods and systems are disclosed for using heuristic refinement and a deep learning model to identify at least one high-quality user search query. Conventional techniques may not be suitable at least because conventional techniques, among other things, do not ensure a high-quality event summary because they may miss essential event facts. Additionally, conventional techniques may rely on user views and clicks to determine which content is popular, but such user involvement is typically inconsistent. Accordingly, improvements in technology relating to providing user recommendations based on user search queries are needed.

Online data services (e.g., news services) play a vital role in disseminating information among web users. A substantial amount of information is published online, and as a result, many challenges arise. For example, users desire to efficiently access their requested information quickly among the substantial amount of information presented to such users. Conventional approaches to such a challenge may rely on web backlog indicators that measure user engagement. For example, conventional approaches may rely on user views and clicks to determine which content is popular, and thus, may be recommended to a user. However, due to differences in online traffic size and user behavior patterns, user involvement is typically inconsistent, which may impact the quality of topic recommendations. Additionally, popular user search queries may be one of the primary sources for providing user recommendations. However, such queries do not ensure a high-quality event summary because they may miss essential event facts. Conventional approaches may include keyword/key phrase extraction, however, such approaches may rely heavily on an adequate amount of text data to identify the common key terms in a given event.

This disclosure provides systems and methods for using heuristic refinement and a deep learning model to identify at least one high-quality user search query from existing reliable sources (e.g., news titles). The systems and methods may also include selecting a high-quality query from queries evaluated by the heuristic refinement and the deep learning model. The systems and methods may also include displaying the high-quality query on a device. Additionally, such a high-quality user search query may be used for providing recommendations.

Advantages of such a system may include providing highly competitive results as high-quality content among user logs. For example, the system may leverage the knowledge derived from large language modeling and combine such knowledge with user log information to generate user log-like text phrases from trusted sources (e.g., news titles). Additional advantages may include automatically generating high-quality representations of information (e.g., topics) to meet a user's attention and interest. For example, by utilizing language models with user queries and additional data (e.g., news titles), the system may generate short text phrases similar to user search queries that may effectively summarize event data. Additional advantages may also include increasing efficiency by utilizing language models, where the language models may only need a little amount of training data. Additional advantages may also include utilizing an ensemble technique to combine the results of the heuristic refinement and the deep learning model by calculating the relevance of generated representation terms to specific content, which may increase performance and deliver substantial performance enhancements. Moreover, deep learning models are adaptable to a variety of tasks relating to automatic text generation.

The systems and methods disclosed herein relate to using heuristic refinement and a deep learning model to identify at least one high-quality user search query. The systems and methods may include filtering, by one or more processors, one or more queries based on one or more user interactions. The systems and methods may include determining, by the one or more processors, at least one candidate query based on the filtered one or more queries. The determining may include determining, by the one or more processors, one or more heuristic candidate queries by applying one or more heuristic processes to the filtered one or more queries, generating, by the one or more processors, one or more model candidate queries based on one or more deep learning model processes, and selecting, by the one or more processors, the at least one candidate query from the one or more heuristic candidate queries or the one or more model candidate queries based on a corresponding aggregated token frequency. The systems and methods may include displaying, by the one or more processors, the at least one candidate query on at least one device.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

As used herein, a “machine-learning model” or a “deep learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model/system is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), decision tree, gradient boosting in a decision tree, deep learning, and/or a deep neural network. Supervised and/or unsupervised training may be employed. For example, supervised learning may include providing training data and classifications corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

### Exemplary Environment

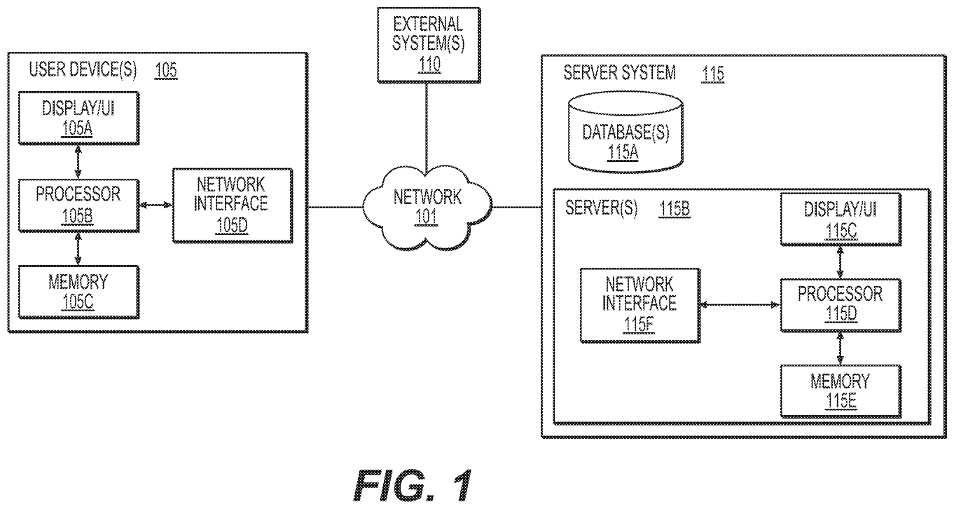

FIG. 1 depicts an exemplary environment 100 that may be utilized with techniques presented herein. One or more user device(s) 105, one or more external system(s) 110, and one or more server system(s) 115 may communicate across a network 101. As will be discussed in further detail below, one or more server system(s) 115 may communicate with one or more of the other components of the environment 100 across network 101. The one or more user device(s) 105 may be associated with a user, e.g., a user associated with one or more of generating, training, or tuning a deep learning model for identifying a high-quality user search query.

In some embodiments, the components of the environment 100 are associated with a common entity, e.g., a content publisher. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, and/or use a machine-learning model to identify a high-quality user search query, among other activities.

The user device 105 may be configured to enable the user to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105.

The user device 105 may include a display/user interface (UI) 105A, a processor 105B, a memory 105C, and/or a network interface 105D. The user device 105 may execute, by the processor 105B, an operating system (O/S) and at least one electronic application (each stored in memory 105C). The electronic application may be a desktop program, a browser program, a web client, or a mobile application program (which may also be a browser program in a mobile O/S), an applicant specific program, system control software, system monitoring software, software development tools, or the like. For example, environment 100 may extend information on a web client that may be accessed through a web browser. In some embodiments, the electronic application(s) may be associated with one or more of the other components in the environment 100. The application may manage the memory 105C, such as a database, to transmit streaming data to network 101. The display/UI 105A may be a touch screen or a display with other input systems (e.g., mouse, keyboard, etc.) so that the user(s) may interact with the application and/or the O/S. The network interface 105D may be a TCP/IP network interface for, e.g., Ethernet or wireless communications with the network 101. The processor 105B, while executing the application, may generate data and/or receive user inputs from the display/UI 105A and/or receive/transmit messages to the server system 115, and may further perform one or more operations prior to providing an output to the network 101.

External systems 110 may be, for example, one or more third party and/or auxiliary systems that integrate and/or communicate with the server system 115 in performing various query analysis tasks. External systems 110 may be in communication with other device(s) or system(s) in the environment 100 over the one or more networks 101. For example, external systems 110 may communicate with the server system 115 via API (application programming interface) access over the one or more networks 101, and also communicate with the user device(s) 105 via web browser access over the one or more networks 101.

In various embodiments, the network 101 may be a wide area network (“WAN”), a local area network (“LAN”), a personal area network (“PAN”), or the like. In some embodiments, network 101 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “VWWV” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 115 may include an electronic data system, e.g., a computer-readable memory such as a hard drive, flash drive, disk, etc. In some embodiments, the server system 115 includes and/or interacts with an application programming interface for exchanging data to other systems, e.g., one or more of the other components of the environment.

The server system 115 may include a database 115A and at least one server 115B. The server system 115 may be a computer, system of computers (e.g., rack server(s)), and/or or a cloud service computer system. The server system may store or have access to database 115A (e.g., hosted on a third party server or in memory 115E). The server(s) may include a display/UI 115C, a processor 115D, a memory 115E, and/or a network interface 115F. The display/UI 115C may be a touch screen or a display with other input systems (e.g., mouse, keyboard, etc.) for an operator of the server 115B to control the functions of the server 115B. The server system 115 may execute, by the processor 115D, an operating system (O/S) and at least one instance of a servlet program (each stored in memory 115E).

The server system 115 may generate, store, train, or use a deep learning model configured to identify a high-quality user search query. The server system 115 may include a deep learning model and/or instructions associated with the deep learning model, e.g., instructions for generating a deep learning model, training the deep learning model, using the deep learning model, etc. The server system 115 may include training data, e.g., user queries.

In some embodiments, a system or device other than the server system 115 is used to generate and/or train the deep learning model. For example, such a system may include instructions for generating the deep learning model, the training data and ground truth, and/or instructions for training the deep learning model. A resulting trained deep learning model may then be provided to the server system 115.

Generally, a deep learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between the user queries and external data, such that the trained deep learning model is configured to determine a signal classification in response to the input user queries based on the learned associations.

In various embodiments, the variables of a deep learning model may be interrelated in any suitable arrangement in order to generate the output. For example, in some embodiments, the deep learning model may include signal processing architecture that is configured to identify, isolate, and/or extract features, patterns, and/or structure in a text. For example, the deep learning model may include one or more convolutional neural network (“CNN”) configured to identify features in the document information data, and may include further architecture, e.g., a connected layer, neural network, etc., configured to identify a high-quality user search query.

Although depicted as separate components in FIG. 1, it should be understood that a component or portion of a component in the environment 100 may, in some embodiments, be integrated with or incorporated into one or more other components. For example, a portion of the display 115C may be integrated into the user device 105 or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to identify a high-quality user search query are discussed in further detail in the methods above. In these methods, various acts may be described as performed or executed by a component from FIG. 1, such as the server system 115, the user device 105, or components thereof. However, it should be understood that in various embodiments, various components of the environment 100 discussed above may execute instructions or perform acts including the acts discussed above and below. An act performed by a device may be considered to be performed by a processor, actuator, or the like associated with that device. Further, it should be understood that in various embodiments, various steps may be added, omitted, and/or rearranged in any suitable manner.

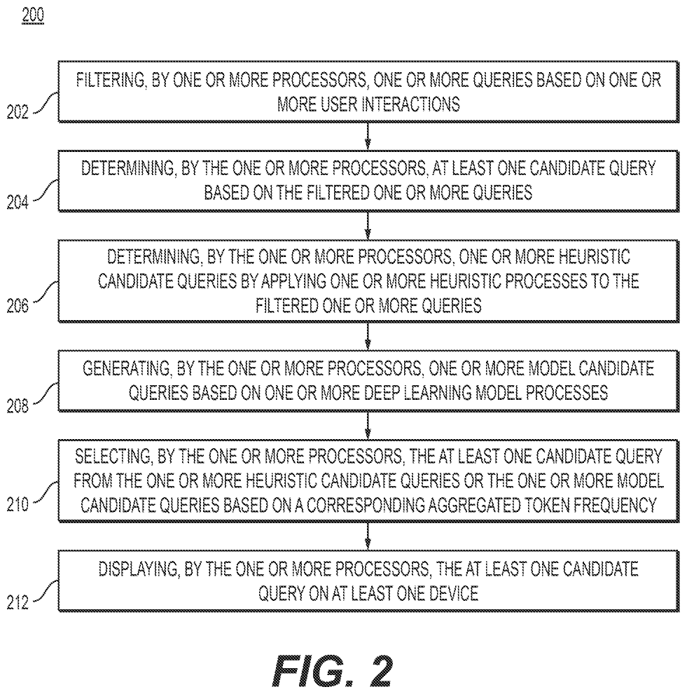

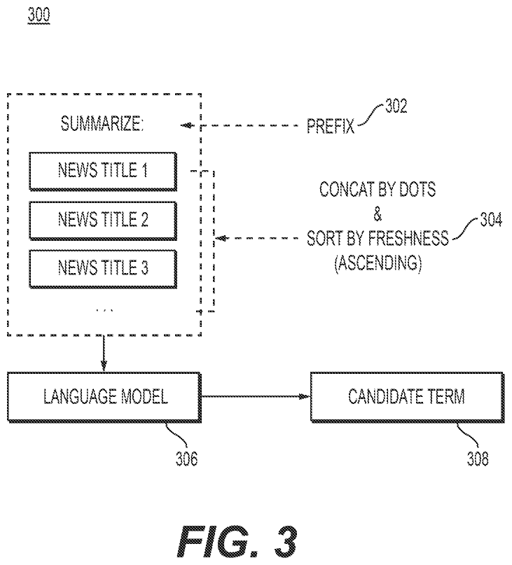

In general, any process or operation discussed in this disclosure that is understood to be computer-implementable, such as the processes illustrated in FIGS. 2-3, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

### Exemplary Method Using Heuristic Refinement and a Deep Learning Model

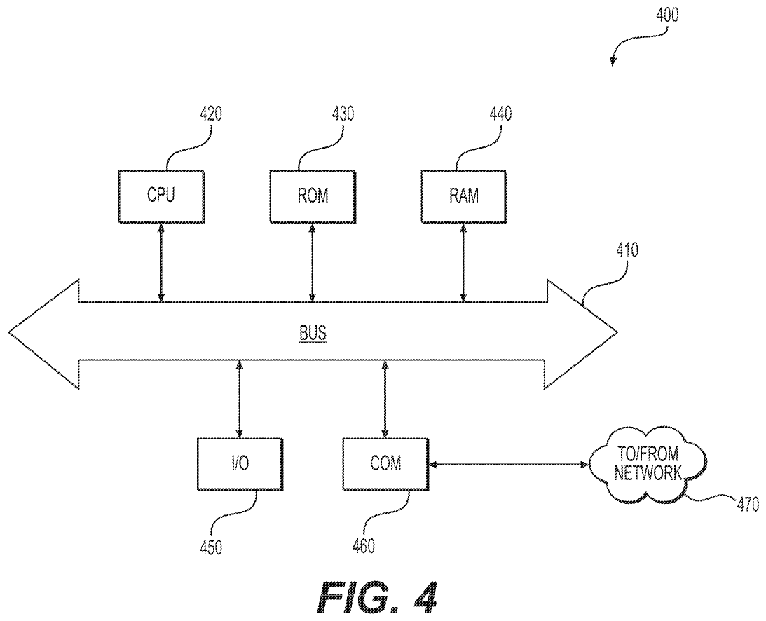

FIG. 2 depicts a flow diagram of an exemplary method 200 using heuristic refinement and a deep learning model to identify at least one high-quality user search query, according to one or more embodiments. Notably, method 200 may be performed by one or more processors of a server that is in communication with one or more user devices and other external system(s) via a network. However, it should be noted that method 200 may be performed by any one or more of the server, one or more user devices, or other external systems. Exemplary method 200 may be executed on one or more components of FIG. 1 or 4.

The method may include receiving, by the one or more processors, the one or more queries from one or more devices. Additionally, or alternatively, the method may include receiving the one or more queries from one or more internal systems and/or one or more external systems. The one or more queries may include a plurality of terms (e.g., keywords). The one or more queries may correspond to searches for particular events (e.g., news events). The plurality of terms may relate to descriptors of the particular events. The one or more devices may correspond to user device(s) 105. In some embodiments, the one or more queries may make up a query log that stores the one or more queries for a particular period of time.

The method may include filtering, by one or more processors, one or more queries based on one or more user interactions (Step 202). The one or more user interactions may include one or more clicks. For example, any queries that are above a particular threshold may be removed. Alternatively, any queries that are below a particular threshold may be removed. In some embodiments, the threshold may correspond to a number of clicks.

The method may include clustering, by the one or more processors, the filtered one or more queries into one or more query groups based on one or more similarities. For example, filtered queries that are lexically and/or semantically similar may be clustered together.

The method may include determining, by the one or more processors, at least one candidate query based on the filtered one or more queries (Step 204). In some embodiments, the determining may be based on the clustered filtered one or more queries. The determining may include determining, by the one or more processors, one or more heuristic candidate queries by applying one or more heuristic processes to the filtered one or more queries (Step 206). The one or more heuristic processes may include at least one of: filtering the filtered one or more queries based on at least one query length, filtering the filtered one or more queries based on at least one popularity score, or applying at least one smoothing strategy to the filtered one or more queries. The at least one query length may include a number of characters in the query. The at least one popularity score may include a click-based popularity score, a view-based popularity score, or a Wilson-based popularity score. The click-based popularity score may be based on the number of user clicks for a corresponding query. The view-based popularity score may be based on the number of user views for a corresponding query. The Wilson-based score may be based on the following:

$${WS}_{pop} = {Wilson}^{-} ( CTR , {N}_{search} ) \times {N}_{search} ,$$

In some embodiments, the popularity score may be calculated by a Wilson-based score with a term length penalty, as shown below:

$${Term}_{pop} = WSpop \times {Term}_{length}$$

Applying the at least one smoothing strategy may include applying an exponential moving average (EMA). For example, the EMA may be utilized for popularity score optimization to smooth the Wilson-based score within a particular time period (e.g., 24 hours).

In some embodiments, the determining may include selecting at least one popular term from one or more term groups based on user query logs. Additionally, or alternatively, the user query logs may contain a subset of queries that occurred within a certain period of time (e.g., the past three hours). In some embodiments, there may be a length limit on the subset of queries. For example, the subset of queries may not contain queries with a length longer than 20 characters. Additionally, each popular term may be associated with a popularity score, which may be calculated by a Wilson-based score with a term length penalty, as shown below:

$${Term}_{pop} = WSpop \times {Term}_{length}$$

The determining may include generating, by the one or more processors, one or more model candidate queries based on one or more deep learning model processes (Step 208). The deep learning model processes may include utilizing one or more pretrained language models (e.g., BART, T5). In some embodiments, the one or more deep learning models may have been pre-trained on one or more datasets (described below).

Generating the one or more model candidate queries based on the one or more deep learning model processes may include receiving, by the one or more processors, term data from one or more external sources, concatenating, by the one or more processors, the term data, extracting, by the one or more processors, one or more tokens from the term data, and applying, by the one or more processors, at least one language model to the one or more tokens to determine the one or more model candidate queries. The term data may include one or more terms, which may be concatenated together, sorted by freshness, and then one or more prefixes may be appended to the beginning of the concatenated term data. Additionally, sorting by freshness may indicate a priority of the terms. The prefix may indicate to the model that the data after the prefix is to be utilized to find the one or more model candidate queries. After the term data has been prepared (e.g., by concatenating the terms, sorting the term data by freshness, and/or appending the prefix), the terms may be extracted and fed into one or more language models. The one or more language models may include additional stored queries. Upon receiving the terms, the one or more language models may then compare the received terms to the additional stored queries, and then based on the comparison, output one or more model candidate terms.

For example, a deep learning model may retrieve one or more news titles that are similar to a query from the user query logs. The one or more news titles may be concatenated via one or more dots and sorted by freshness. Additionally, a prefix (e.g., “summarize:”) may be appended to the beginning of the concatenated news titles. After the queries have been prepared, the queries may be fed into one or more language models. The one or more language models may include stored news titles. Upon receiving the queries, the one or more language models may then compare the received queries to the stored news titles, and then output one or more model candidate terms.

For example, in some embodiments, the method may also include training the deep learning model to automatically recognize a language pattern and generate queries similar to those provided by one or more users. For example, the high-quality user query logs may serve as labels that are used as input to train the deep learning model. More specifically, the query logs may include one or more queries, which may correspond to one or more labels. The heuristic filtering process may be applied to the query logs to determine the popularity of a query by statistically altering the click and view counts of the user (e.g., by the Wilson score). After collecting the one or more labels, associated information (e.g., associated news information, news titles) may be extracted from one or more associated information systems (e.g., a news search recommender system). Additionally, or alternatively, grouping and/or deduplication post-processing techniques may be applied to the one or more labels and/or the associated information, which may result in a training dataset for the deep learning model. In some embodiments, the training dataset may be enhanced by augmenting the training dataset with one or more longer queries. For example, each label may be substituted with a more detailed and improved term. In some embodiments, the deep learning model may be trained using the training dataset with token masking (e.g., 500 epochs, 15% masking).

The determining may include selecting, by the one or more processors, the at least one candidate query from the one or more heuristic candidate queries or the one or more model candidate queries based on a corresponding aggregated token frequency (Step 210). In some embodiments, the selecting may include ranking all of the one or more heuristic candidate queries and the one or more model candidate queries together, and then selecting at least one of the top ranked query.

The token coverage calculation may focus on the coverage of core content of the candidate terms that appears in the targeted content (e.g., news titles). The written language to token conversion may involve two steps: stemming and stop words removal. In the stemming step, each word in the written language may be converted to its root version. For example, “likes, liked, likely or liking” may all be converted to “like”. The stemming process may improve the terms versus content comparison coverage. The stop words removal process may involve removing words that may not contain necessary meaningful information for the coverage calculation. Such words may include general words like “the, of, and, is”, or some specific words that may be ignored (e.g., “today, now, recently”).

The method may include determining, by the one or more processors, the aggregated token frequency for each of the one or more heuristic candidate queries and each of the one or more model candidate queries, the aggregated token frequency based on the term data and a frequency of the one or more heuristic candidate queries or the one or more model candidate queries in the term data. For example, the aggregated token frequency may be calculated as the following:

$$AggTokFreq ( T , d ) = {\sum }_{t ∈ T} {f}_{t , d} .$$

In the above equation, T may include the candidate term generated by each approach, t may include the token in T, d may include the concatenated data, and f_{t,d} may include the frequency of the term t in d. In some embodiments, the token may be determined by a process of converting a term to a token, as described above. The tokenization process may include determining the fundamental term of each word. For example, the term “scores” may have a corresponding token of “score.” Additionally, for example, the table below shows among three candidate results (e.g., an enhanced heuristic selection of a query, automatically generated text from a BART-based method, and automatically generated text from a T5-based approach), the third approach has the highest aggregated token frequency.

| WEMA2 | T5-base + E | BART-base + E + L |
|---|---|---|
| caravan | migrant caravan | migrant caravan in Mexico |

For example, by comparing three distinct techniques with the targeted news content text sources, the most relevant outcome for each event may be selected by calculating the token level coverage.

The method may include selecting, by the one or more processors, the one or more heuristic candidate queries and each of the one or more model candidate queries with a highest aggregated token frequency as the at least one candidate query. Additionally, the at least one candidate query may have a query length below a threshold. For example, the threshold may be 30 characters, where the at least one candidate query has a length below 30 characters.

The selecting may include assigning, by the one or more processors, a popularity score to each filtered one or more queries in the one or more query groups. The popularity score may be determined based on the above description. The selecting may also include selecting, by the one or more processors, based on the popularity score, at least one popular query for each of the one or more query groups. For example, the query with the highest popularity score may be selected from each of the one or more query groups.

The method may include displaying, by the one or more processors, the at least one candidate query on at least one device (Step 212). For example, the at least one device may include user device(s) 104. Additionally, or alternatively, the at least one device may be a part of external system(s) 110. Additionally, or alternatively, the at least one candidate query may be sent to a device that provides recommendations to users. The at least one candidate query may be utilized to provide recommendations to users. Such recommendations may be displayed on a user device (e.g., user device(s) 104), where a user may be able to interact with the displayed recommendations. For example, the user may be able to indicate whether the displayed recommendations are applicable to the user.

Although FIG. 2 shows example blocks of exemplary method 200, in some implementations, the exemplary method 200 may include additional blocks, fewer blocks, different blocks, or differently arranged blocks than those depicted in FIG. 2 Additionally, or alternatively, two or more of the blocks of the exemplary method 200 may be performed in parallel.

### Exemplary Method for Determining a Candidate Term

FIG. 3 depicts a schematic diagram of an exemplary method 300 for determining a candidate term, according to one or more embodiments. User query logs may serve as labels to train at least one deep learning model. The deep learning model may be able to automatically recognize a language pattern, as well as generate one or more queries that are similar to those provided by one or more users.

The method may include updating term data by appending one or more prefixes (e.g., “Summarize”) to the term data (Step 302). The prefixes may be appended to the beginning of the term data. The prefixes may follow a standard convention as other pre-trained tasks, where the prefixes may indicate to one or more language models. The term data may include one or more sets of data, which may have been received from one or more external sources. In some embodiments, the term data may include one or more news titles from one or more news sources. The news titles may have been concatenated by one or more dots (Step 304). Additionally, the news titles may be sorted by freshness (e.g., ascending order) (Step 304). The order may also indicate a priority of the term data. The updated term data may be input into one or more language models (Step 306). The language models may include open-source, sequence-to-sequence capable, pretrained language models (e.g., BART, T5). Additionally, model checkpoints may be adopted (e.g., BART-base, BART-large, T5-base, or T5-large). The language models may have been pre-trained with one or more summarization tasks on one or more datasets. Based on the input term data, the language model may then return at least one candidate term (Step 308).

### Exemplary Computer System

FIG. 4 illustrates a high-level functional block diagram of an exemplary computer system 400, in which embodiments of the present disclosure, or portions thereof, may be implemented, e.g., as computer-readable code. For example, each of the exemplary devices and systems described above with respect to FIG. 4 can be implemented in computer system 400 using hardware, software, firmware, tangible computer readable media having instructions stored thereon, or a combination thereof and may be implemented in one or more computer systems or other processing systems. Hardware, software, or any combination of such may embody any of the modules and components in FIG. 4, as described above.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor, a plurality of processors, or combinations thereof. Processor devices may have one or more processor “cores.”

Various embodiments of the present disclosure, as described above in the examples of FIGS. 1-3 may be implemented using computer system 400, shown in FIG. 4. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

FIG. 4 provides a functional block diagram illustration of general purpose computer hardware platforms. FIG. 4 illustrates a network or host computer platform 400, as may typically be used to implement a server, such as user device(s) 105, external system(s) 110, and server system 115. It is believed that those skilled in the art are familiar with the structure, programming, and general operation of such computer equipment and, as a result, the drawings should be self-explanatory.

A platform for a server or the like 400, for example, may include a data communication interface for packet data communication 460. The platform may also include a central processing unit (CPU) 420, in the form of one or more processors, for executing program instructions. The platform typically includes an internal communication bus 410, program storage, and data storage for various data files to be processed and/or communicated by the platform such as ROM 430 and RAM 440, although the computer platform 400 often receives programming and data via network communications 470. The hardware elements, operating systems, and programming languages of such equipment are conventional in nature, and it is presumed that those skilled in the art are adequately familiar therewith. The computer platform 400 also may include input and output ports 450 to connect with input and output devices such as keyboards, mice, touchscreens, monitors, displays, etc. Of course, the various computer platform functions may be implemented in a distributed fashion on a number of similar platforms, to distribute the processing load. Alternatively, the computer platforms may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as those used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It would also be apparent to one of skill in the relevant art that the present disclosure, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

It is to be understood that both the foregoing general description and the following detailed description are exemplary and explanatory only and are not restrictive of the disclosed embodiments, as claimed.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A computer-implemented method for using heuristic refinement and a deep learning model to identify at least one high-quality user search query, the method comprising:
filtering, by one or more processors, one or more queries based on one or more user interactions;
determining, by the one or more processors, at least one candidate query based on the filtered one or more queries, the determining including:
determining, by the one or more processors, one or more heuristic candidate queries by applying one or more heuristic processes to the filtered one or more queries;
generating, by the one or more processors, one or more model candidate queries based on one or more deep learning model processes; and
selecting, by the one or more processors, the at least one candidate query from the one or more heuristic candidate queries or the one or more model candidate queries based on a corresponding aggregated token frequency; and
displaying, by the one or more processors, the at least one candidate query on at least one device.

2. The computer-implemented method of claim 1, wherein the one or more user interactions include one or more clicks.

3. The computer-implemented method of claim 1, wherein the one or more heuristic processes includes at least one of: filtering the filtered one or more queries based on at least one query length, filtering the filtered one or more queries based on at least one popularity score, or applying at least one smoothing strategy to the filtered one or more queries.

4. The computer-implemented method of claim 3, wherein the at least one popularity score includes a click-based popularity score, a view-based popularity score, or a Wilson-based popularity score.

5. The computer-implemented method of claim 1, wherein generating the one or more model candidate queries based on the one or more deep learning model processes further comprises:
receiving, by the one or more processors, term data from one or more external sources;
concatenating, by the one or more processors, the term data;
extracting, by the one or more processors, one or more tokens from the term data; and
applying, by the one or more processors, at least one language model to the one or more tokens to determine the one or more model candidate queries.

6. The computer-implemented method of claim 5, further comprising:
determining, by the one or more processors, the aggregated token frequency for each of the one or more heuristic candidate queries and each of the one or more model candidate queries, the aggregated token frequency based on the term data and a frequency of the one or more heuristic candidate queries or the one or more model candidate queries in the term data; and
selecting, by the one or more processors, the one or more heuristic candidate queries and each of the one or more model candidate queries with a highest aggregated token frequency as the at least one candidate query.

7. The computer-implemented method of claim 1, wherein a query length of the at least one candidate query is below a threshold.

8. The computer-implemented method of claim 1, the method further comprising:
receiving, by the one or more processors, the one or more queries from one or more devices.

9. The computer-implemented method of claim 1, wherein the one or more queries include a plurality of terms.

10. The computer-implemented method of claim 1, the method further comprising:
clustering, by the one or more processors, the filtered one or more queries into one or more query groups based on one or more similarities.

11. The computer-implemented method of claim 10, wherein the selecting further comprises:
assigning, by the one or more processors, a popularity score to each filtered one or more queries in the one or more query groups; and
selecting, by the one or more processors, based on the popularity score, at least one popular query for each of the one or more query groups.

12. A computer system for using heuristic refinement and a deep learning model to identify at least one high-quality user search query, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
filtering one or more queries based on one or more user interactions;
determining at least one candidate query based on the filtered one or more queries, the determining including:
determining one or more heuristic candidate queries by applying one or more heuristic processes to the filtered one or more queries;
generating one or more model candidate queries based on one or more deep learning model processes; and
selecting the at least one candidate query from the one or more heuristic candidate queries or the one or more model candidate queries based on a corresponding aggregated token frequency; and
displaying the at least one candidate query on at least one device.

13. The computer system of claim 12, wherein generating the one or more model candidate queries based on the one or more deep learning model processes further comprises:
receiving term data from one or more external sources;
concatenating the term data;
extracting one or more tokens from the term data; and
applying at least one language model to the one or more tokens to determine the one or more model candidate queries.

14. The computer system of claim 13, further comprising:
determining the aggregated token frequency for each of the one or more heuristic candidate queries and each of the one or more model candidate queries, the aggregated token frequency based on the term data and a frequency of the one or more heuristic candidate queries or the one or more model candidate queries in the term data; and
selecting the one or more heuristic candidate queries and each of the one or more model candidate queries with a highest aggregated token frequency as the at least one candidate query.

15. The computer system of claim 12, the functions further comprising:
clustering the filtered one or more queries into one or more query groups based on one or more similarities.

16. The computer system of claim 15, wherein the selecting further comprises:
assigning a popularity score to each filtered one or more queries in the one or more query groups; and
selecting based on the popularity score, at least one popular query for each of the one or more query groups.

17. A non-transitory computer-readable medium containing instructions for using heuristic refinement and a deep learning model to identify at least one high-quality user search query, the instructions comprising:
filtering, by one or more processors, one or more queries based on one or more user interactions;
determining, by the one or more processors, at least one candidate query based on the filtered one or more queries, the determining including:
determining, by the one or more processors, one or more heuristic candidate queries by applying one or more heuristic processes to the filtered one or more queries;
generating, by the one or more processors, one or more model candidate queries based on one or more deep learning model processes; and
selecting, by the one or more processors, the at least one candidate query from the one or more heuristic candidate queries or the one or more model candidate queries based on a corresponding aggregated token frequency; and
displaying, by the one or more processors, the at least one candidate query on at least one device.

18. The non-transitory computer-readable medium of claim 17, wherein the one or more user interactions include one or more clicks.

19. The non-transitory computer-readable medium of claim 17, wherein the one or more heuristic processes includes at least one of: filtering the filtered one or more queries based on at least one query length, filtering the filtered one or more queries based on at least one popularity score, or applying at least one smoothing strategy to the filtered one or more queries.

20. The non-transitory computer-readable medium of claim 19, wherein the at least one popularity score includes a click-based popularity score, a view-based popularity score, or a Wilson-based popularity score.
